(19) United States
(12) Patent Application Publication
(10) Pub. No.: US 2021/0044154 A1
(43) Pub. Date: Feb. 11, 2021

(54) PASSIVE MULTI-CORE REPEATER FOR WIRELESS POWER CHARGING

(71) Applicant: POWERMAT TECHNOLOGIES LTD., PETACH TIKVA (IL)

(72) Inventor: ITAY SHERMAN, HOD HASHARON (IL)

(21) Appl. No.: 16/967,034

(22) PCT Filed: Feb. 4, 2019
(86) PCT No.: PCT/IL2019/050137

§ 371 Date: Aug. 3, 2020

Related U.S. Application Data
(60) Provisional application No. 62/626,094, filed on Feb. 4, 2018.

(51) Int. Cl. H02J 50/40; H02J 50/12; H02J 50/80

(52) U.S. Cl. CPC H02J 50/402; H02J 50/80; H02J 50/12

(57) ABSTRACT

A multi-coil repeater is provided for wireless power transfer from a transmitter, having an adjustable operation frequency, to a receiver coil having a ferrite layer behind it, the multi-coil repeater comprising: an array of passive repeater transmitting coils (RTC) in a single layer; a ferrite layer having a receiver facing side and a transmitter facing side, wherein the array is positioned on the receiver facing side; and a repeater receiving coil (RRC) positioned on the transmitter facing side; wherein each RTC of the array has a resonance capacitor to form a branch having a resonance frequency, wherein all branches are parallelly wired together, wherein a receiver placed above the receiver facing side causes the resonance frequency of at least one branch situated directly below the receiver to drop to a different resonance frequency; and wherein the transmitter adjusts its operational frequency to the RRC to be close to the different resonance frequency of the at least one branch.

### CROSS-REFERENCE TO RELATED APPLICATION

This application claims priority from co-pending; U.S. Provisional Patent Application No. 62/626,094, by Itay Sherman, titled “Fully passive multi coil array for wireless power”, filed Feb. 4 2017; which is incorporated by reference for all purposes.

### TECHNICAL FIELD

The present disclosed subject matter relates to wireless power charging systems. More particularly, the present disclosed subject matter relates to passive repeater and methods for wireless power charging.

### BACKGROUND

Growing demand for wireless power charging systems led to dramatic deployments increase, in a wide variety of venues, that consequently raises the need for increasing the effective charging area and distance between the transmitter and the receiver in the system.

Wireless power charging systems are usually deployed in public facilities such as restaurants, coffee shops, airports, bus stations; train stations, banks, schools, libraries, hotels, official building, or the like. Typically, the systems are installed on top of surfaces, such as tables, bars, or the like that are accessible to users, thus require decorative appearance and hazards free installation. Meeting these requirements on one hand and distance plus area limitations on the other, requires wiring to be routed on top of the surface as well as drilling the surface to meet the distance limitation. In some cases, the transmitter of such commercially available systems can be installed inside the cutout hole in the surface. This complicates the installation and raises its cost, on top of damaging the customer's furniture.

### BRIEF SUMMARY

According to a first aspect of the present disclosed subject matter, a multi-coil repeater for wireless power transfer from a transmitter, having an adjustable operation frequency, to a receiver coil having a ferrite layer behind it, the multi-coil repeater comprising:
an array of passive repeater transmitting coils (RTC) in a single layer;
a ferrite layer having a receiver facing side and a transmitter facing side, wherein the array is positioned on the receiver facing side; and
a repeater receiving coil (RRC) positioned on the transmitter facing side;
wherein each RTC of the array has a resonance capacitor to form a branch having a resonance frequency, wherein all branches are parallelly wired together, wherein a receiver placed above the receiver facing side causes the resonance frequency of at least one branch situated below the receiver to drop to a different resonance frequency; and wherein the transmitter adjusts its operational frequency to the RRC to be close to the different resonance frequency of the at least one branch.

In some exemplary embodiments, the RTC is substantially smaller than the RRC.

In some exemplary embodiments, the RTC is substantially smaller than a typical receiver coil to enable coverage of at least RTCs by the receiver coil.

In Accordance with another aspect, a method for adjusting an operational frequency for the multi-coil repeater as described herein before is provided, the method comprising:
scanning a range of operational frequencies of the transmitter and registering a power output for each frequency of the range of the operational frequencies;
determining a lowest frequency in which the power output is minimal;
set the operational frequency to be substantially close to the lowest frequency and start transmitting to the RRC.

In some exemplary embodiments, said adjusting an operational frequency is repeated sequentially for detecting a movement of the receiver on the receiver facing side and additional receivers.

In some exemplary embodiments, the transmitter adjusts the power output to satisfy power needs of the receiver.

In some exemplary embodiments, said lowest frequency in which the power output is minimal is a joint resonance frequency of the at least one branch and the receiver coil of a receiver positioned above the at least one branch.

In some exemplary embodiments, the joint resonance frequency is substantially lower than a resonance frequency of a branch that doesn't have a receiver above it, thereby the operational frequency effectively selects only the at least one branch positioned bellow the receiver.

Unless otherwise defined, all technical and scientific terms used herein have the same meaning as commonly understood by one of ordinary skill in the art to which this disclosed subject matter belongs. Although methods and materials similar or equivalent to those described herein can be used in the practice or testing of the present disclosed subject matter, suitable methods and materials are described below. In case of conflict, the specification, including definitions, will control. In addition, the materials, methods, and examples are illustrative only and not intended to be limiting.

### BRIEF DESCRIPTION OF THE DRAWINGS

Some embodiments of the disclosed subject matter described, by way of example only, with reference to the accompanying drawings. With specific reference now to the drawings in detail, it is stressed that the particulars shown are by way of example and for purposes of illustrative discussion of the preferred embodiments of the present disclosed subject matter only, and are presented in the cause of providing what is believed to be the most useful and readily understood description of the principles and conceptual aspects of the disclosed subject matter. In this regard, no attempt is made to show structural details of the disclosed subject matter in more detail than is necessary for a fundamental understanding of the disclosed subject matter, the description taken with the drawings making apparent to those skilled in the art how the several forms of the disclosed subject matter may be embodied in practice.

In the drawings:

FIG. 1 illustrates a top view of a portion of a multi-coil repeater, in accordance with some exemplary embodiments of the disclosed subject matter;

FIG. 2A illustrates a cross-sectional view of a wireless power charging system that utilizes a multi-coil repeater, in accordance with some exemplary embodiments of the disclosed subject matter;

FIG. 2B illustrates a cross-sectional view of another wireless power charging system that utilizes a multi-coil repeater, in accordance with some exemplary embodiments of the disclosed subject matter;

FIG. 3 illustrates a top view of a receiver of the wireless power charging system in FIG. 2B, in accordance with some exemplary embodiments of the disclosed subject matter;

FIG. 4 illustrates an electrical diagram of a multi-coil repeater, in accordance with some exemplary embodiments of the disclosed subject matter; and

FIG. 5 illustrates a flowchart diagram of a method of using wireless power charging system with multi-coil repeater, in accordance with some exemplary embodiments of the disclosed subject matter.

### DETAILED DESCRIPTION

Before explaining at least one embodiment of the disclosed subject matter in detail, it is to be understood that the disclosed subject matter is not limited in its application to the details of construction and the arrangement of the components set forth in the following description or illustrated in the drawings. The disclosed subject matter is capable of other embodiments or of being practiced or carried out in various ways. Also, it is to be understood that the phraseology and terminology employed herein is for the purpose of description and should not be regarded as limiting. The drawings are generally not to scale. For clarity, non-essential elements were omitted from some of the drawings.

The terms “comprises”, “comprising”, “includes”, “including”, and “having” together with their conjugates mean “including but not limited to”. The term “consisting of” has the same meaning as “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this disclosed subject matter may be presented in a range format. It should be understood that the description in range format is merely for convenience and brevity and should not be construed as an inflexible limitation on the scope of the disclosed subject matter. Accordingly, the description of a range should be considered to have specifically disclosed all the possible sub-ranges as well as individual numerical values within that range.

It is appreciated that certain features of the disclosed subject matter, which are, for clarity, described in the context of separate embodiments, may also be provided in combination in a single embodiment. Conversely, various features of the disclosed subject matter, which are, for brevity, described in the context of a single embodiment, may also be provided separately or in any suitable sub-combination or as suitable in any other described embodiment of the disclosed subject matter. Certain features described in the context of various embodiments are not to be considered essential features of those embodiments, unless the embodiment is inoperative without those elements.

It is an object of the present disclosed subject matter to provide a repeater operable to transfer power from a transmitter to a receiver of commercially available portable devices. The disclosed repeater is designed to provide wireless power charging across large surface area without creating significant magnetic field in areas outside the receiver of the devices.

It is another object of the present subject matter to provide the repeater with a plurality of identical coils lined up in an array formation on a single layer, i.e. no overlapping coils that faces the receiver. Additionally, the repeater can be provided with a ferrite layer for effectively increasing the inductance between the receiver and a selected repeater coil.

It is yet another object of the present disclosure to enable passive selection of at least one coil of the plurality of coils to be activated while the receiver is placed on a portion of the large surface area, while disabling and/or reduce to minimum current flowing in the rest of the coils.

It is yet another object of the present disclosure to extend the smart inductive technology that allows under surface installation to support multi-coil design. It will be noted that the repeater described in the present disclosure is equipped with a single coil facing the transmitter that is situated on opposite side of the multi-coils.

Yet another object of the present disclosure is to provide wireless power charging of up to 65 watts to commercially available portable devices such as laptops or the like, by using fully passive components to achieve this objective.

It is therefore provided in accordance with one aspect of the disclosed subject matter, a multi-coil repeater for wireless power transfer from a transmitter having an adjustable operation frequency to a receiver coil having a ferrite layer behind it, the multi-coil repeater comprising:

an array of passive repeater transmitting coils (RTC) in a single layer,

a ferrite layer having a receiver facing side and a transmitter facing side, wherein the array is positioned on the receiver facing side, and

a repeater receiving coil (RRC) positioned on the transmitter facing side.

Each RTC of the array has a resonance capacitor to form a branch having a resonance frequency, wherein all branches are parallelly wired together, wherein a receiver placed above the receiver facing side causes the resonance frequency of at least one branch situated directly below the receiver to drop to a different resonance frequency; and wherein the transmitter adjusts its operational frequency to the RRC to be close to the different resonance frequency of the at least one branch.

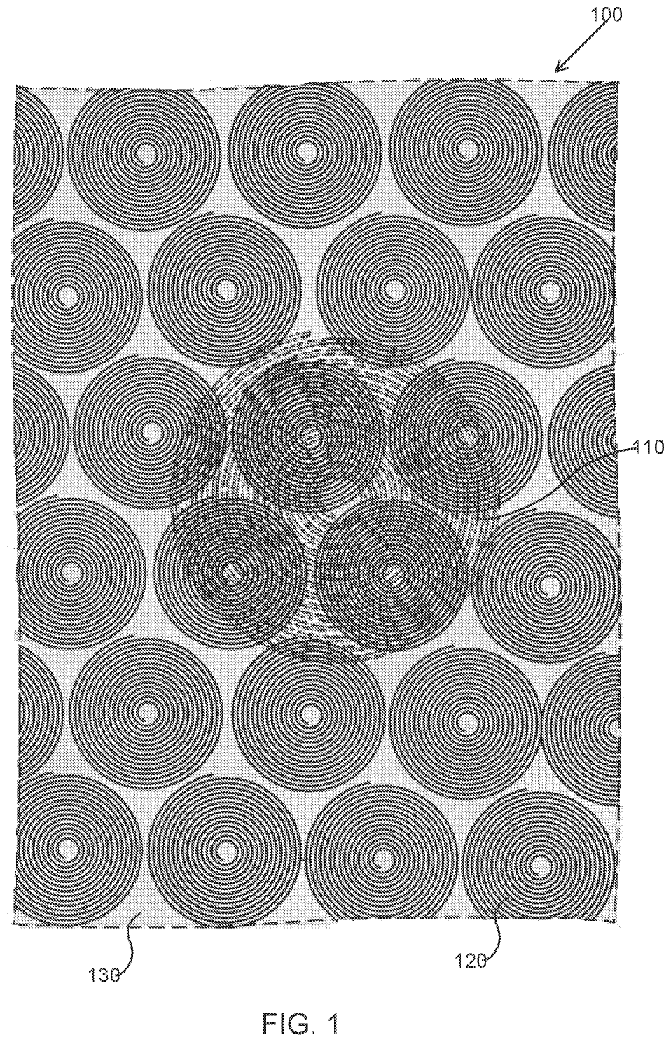

Referring now to FIG. 1 illustrating a top view of a portion of a multi-coil repeater, in accordance with some exemplary embodiments of the disclosed subject matter. The multi-coil repeater 100 may comprise a repeater receiving coil (RRC) 110, a plurality of repeater transmitting coils (RTC) 120 and a repeater's ferrite 130.

In some exemplary embodiments, repeater 100 comprises the following three layers: an outer receiver facing layer (receiver side), an outer transmitter facing layer (transmitter side) and a ferrite layer situated in between the outer receiver facing layer and the outer transmitter facing layer. In some exemplary embodiments, an outer receiver facing layer can be an array made of the plurality of RTCs 120 that are each situated one next to the other on the same surface. The RTCs 120 may be arranged as an array having a square pattern formation, a hexagon pattern formation, or the like.

In some exemplary embodiments, the surface on which the plurality of RTC 120 are situated is the repeater's ferrite 130 that extends along the length and width of a platform of the repeater 100, so all the RTCs 120 are residing within the ferrite 130 perimeter. In some exemplary embodiments, ferrite 130 may comprise a plurality of sides partitions adapted to envelope each or a group of RTCs 120, thus also define a formation of an array. In some exemplary embodiments, the partitions between each RTC 120 or a group RTCs 120 prevent or reduce cross inductance between them.

In some exemplary embodiments, the repeater 100 comprises the RRC 110 situated on the outer layer that is opposite to the RTCs 120. It should be noted that surface area of RRC 110 can be substantially larger than the surface area of an RTC 120. In some exemplary embodiments, the surface area and the inductance of the RTCs 120 are the same. Additionally or alternatively, the inductance of the RTCs 120 can vary, however their surface area is smaller than the RTC 110.

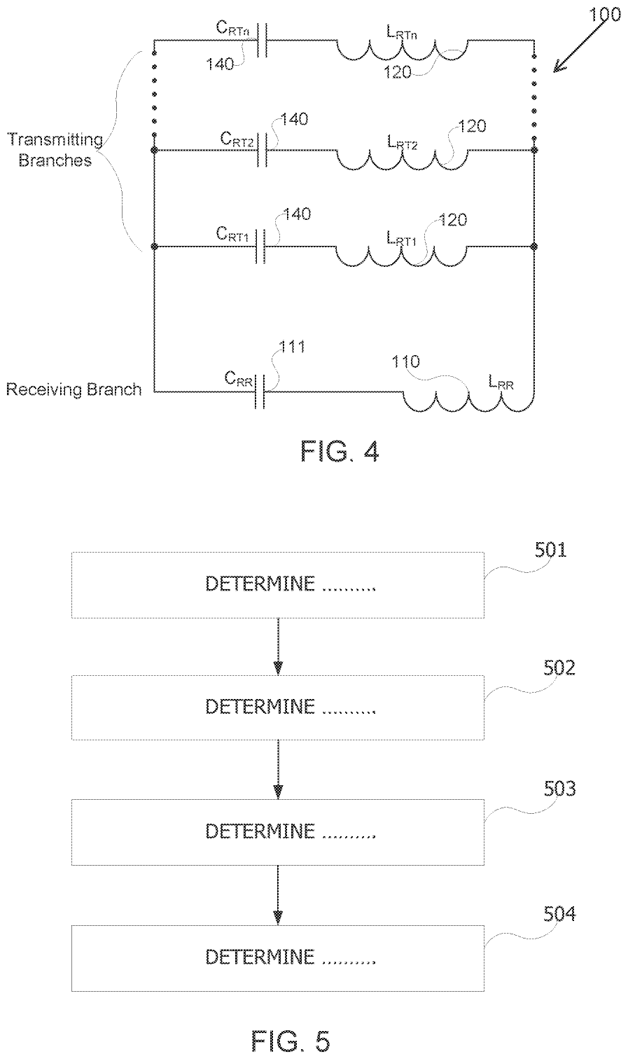

Referring now to FIG. 4 illustrating an electrical diagram of the multi-coil repeater, in accordance with some exemplary embodiments of the disclosed subject matter. The multi-coil repeater 100 comprises a plurality of coils L_{RT1} to L_{RTn}, such as the RTCs 120, of FIG. 1, wherein the subscript 1 through n indicates the position of the L_{RT} in the multi-coil repeater 100. In this embodiment, L_{RT1} through L_{RTn} coils are identical and thus, will be refer hereinafter as LRT or RTCs 120. Each RTCs 120 (L_{RT}) of the repeater 100 have a repeater transmitting capacitor 140, marked as C_{RT1} to C_{RTn} wherein the subscript 1 through n indicates the L_{RT} that the C_{RT} is associated with. Since in this embodiment the C_{RT1} through C_{RTn} capacitors are identical, they will be referred hereinafter as C_{RT}. As shown in the electrical diagram of FIG. 4, each coil L_{RT} is connected in series to its associated capacitor C_{RT} to form a transmitting branch that has a given resonance frequency. The values of the L_{RT} coils and the C_{RT} capacitor are selected to satisfy conditions that shall be described in further details below.

In some exemplary embodiments, all transmitting branches are connected in parallel and since all branches have the same values, they also have the same resonance frequency.

In some exemplary embodiments of the disclosed subject matter, the multi-coil repeater 100 comprises a receiving branch that is comprised of coil LRR, such as RRC 110 of FIG. 1, and a repeater receiving capacitor 111, marked as CRR. It should be noted that, coil LRR and capacitor CRR are connected to one another in series and the receiving branch is connected in parallel to the transmitting branches. The values of coil LRR and capacitor CRR are selected to satisfy conditions that shall be described in further details herein below.

It should also be noted that the electrical diagram of FIG. 4, depicting the multi-coil repeater 100 is a passive circuit, i.e. doesn't have wired power source. Yet, power induced to the receiving branch is transferred by wires to the transmitting branch.

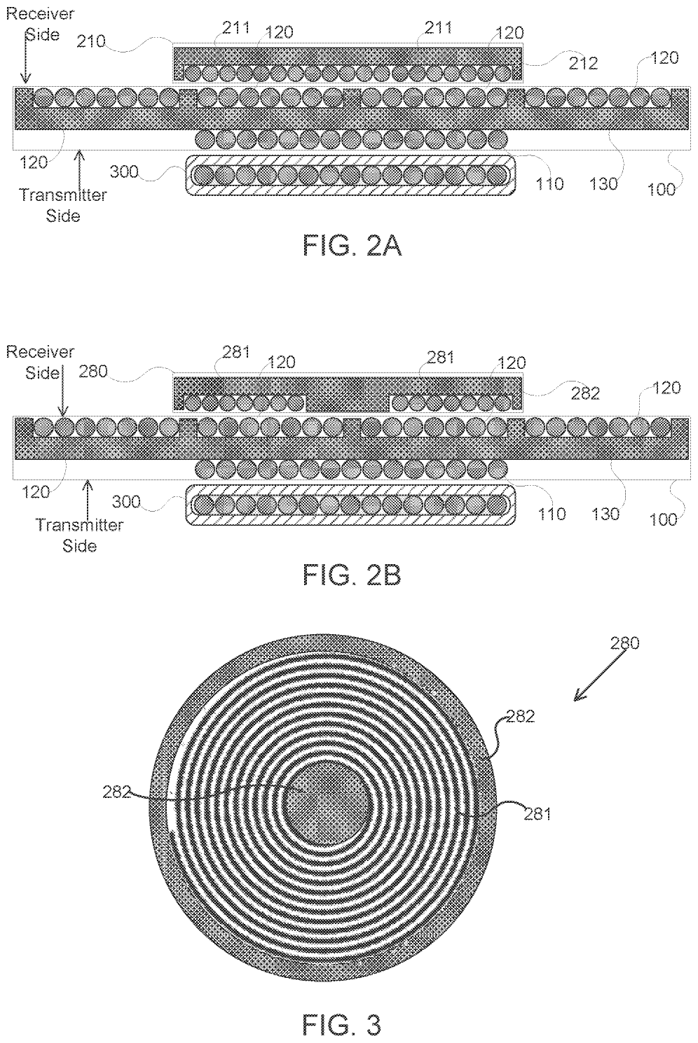

Referring now to FIGS. 2A and 2B are illustrating a cross-section view of two wireless power charging systems that utilize the multi-coil repeater 100, in accordance with some exemplary embodiments of the disclosed subject matter. The wireless power charging systems comprises a transmitter 300, a repeater 100 and either a receiver 200 or a receiver 280.

The description of transmitter 300 as described in PCT/IL2018/050256 is herein incorporated by reference in its entirety into the specification, to the same extent as if it was specifically and individually indicated to be incorporated herein by reference.

In some exemplary embodiments, the repeater 100 is positioned in such a way that the transmitter side, i.e. RRC 110 layer, faces transmitter 300 and the receiver side, i.e. RTC 120 layer, faces receiver 200.

In some exemplary embodiments, transmitter 300 comprises a transmitter coil; a transmitter capacitor; a power-supply, and a transmitter electronics, all incorporated in transmitter 300. It will be noted that a transmitter coil of transmitter 300 and RRC 110 of the repeater are substantially aligned to face one another, for optimizing the inductance between the two, as depicted in FIGS. 2A and 2B. It should also be noted that optimal alignment between the two is typically achieved in an installation process.

In some exemplary embodiments, multi-coil repeater 100 have a shape and form factor of a mat, a pad, a saucer, a coaster, a combination thereof, or the like. The repeater 100 is configured for inductively (wirelessly) charge devices such as tablets, laptop, smartphones, or any chargeable mobile handsets that have receiver 200, a receiver 280 or the like. The receiver of such devices comprises a receiver coil 211 (FIG. 2A) or 281 (FIG. 2B) facing the outer side of the device and ferrite 212 (FIG. 2A) or 282 (FIG. 2B) covering the opposite side of coil 211 (FIG. 2A) or 281 (FIG. 2B).

In some exemplary embodiments, the surface area of coil 211/281 is larger than the surface area of one RTC 120. Preferably, the RTC 120 diameter/length is approximately half of the overall diameter/length of either coil 211 or coil 281. In some exemplary embodiments, coil 281 is provided with ferrite 282 having a center, sized to be slightly larger than the diameter/length of one RTC 120, as depicted in FIGS. 2B and 3.

It should be noted that coil 211/281, placed on the receiver side of repeater 100, and a given RTC 120 on which coil 211/281 is placed, are effectively sandwiched between two ferrites, i.e. ferrite 130 and ferrite 212/282. it is also possible that coil 211/281 will be placed above a portion of multiple RTCs 120 (partially covering), which will effectively sandwich all the coils in between the listed above two ferrites.

The effect of such structure is to significantly increase the inductance of the given RTC 120 vs. its inductance when it is open to the air. The increase factor of inductance is denoted as [F], typically [F] vary between 2.5-3 for RTC 120 that is fully covered by coil 211 and up to 4 for RTC 120 that is fully covered by coil 281. Resulting of the inductance increase, the resonance frequency of branches with RTC 120 that are covered by coil 211/281 will shift compared to non-covered coils, where the coil having most coverage will shift the most.

The following formulas provided below are an exemplary way for calculating the required values of the multi-coil repeater 100 in order to satisfy the conditions hereinafter.

In some exemplary embodiments, the values of C_{RR} and L_{RR} can be calculated for yielding a joint resonance point with the transmitter 300 resonance circuit that is at or substantially close to a preferred operational frequency [fop].

In some exemplary embodiments, the values of C_{RT} and L_{RT} can be calculated to yield a resonance point that is at or substantially close to the preferred operational frequency [fop] while receiver 210/280 is placed on the receiver side of the repeater at max load.

The following table describes the meanings of the formula's components.

| | |
|---|---|
| Zₙₗ | Impedance of an RTC 120 |
| w | Angular frequency of power carrier |
| L_{TS} | Inductance of the RTC 120 |
| C_{TS} | Capacitance repeater transmitting capacitor 140 |
| R′ | Parasitic resistance of a transmitting branch (includes ACR |
| | of coil and ESR of capacitor) |
| Zₗ | Impedance of the transmitting branch while receiver 210/280 |
| | is placed on it and it is loaded |
| k | coupling factor between L_{TS} facing coil and coil 211/281 |
| Lₛ | Inductance of coil 211/281 |
| Yₛ | Ratio between the sum of impedance of the transmitting branch |
| | and the impedance of coil 211/281 |
| Rₗ | Resistance of receiver 210/280 load |
| F | Inductance increase factor when receiver 210/280 is placed on |
| | top of one or more RTC 120. |

The impedance of a transmitting branch is given by:

$${Z}_{nl} = {iwL}_{RT} + \frac{1}{{iwC}_{RT}} + {R}^{′}$$

The impedance of the same branch while receiver 210/280 is placed on it while drawing maximum power is changing due to coupling with the receiver, and in addition due to the change in inductance of the CRT 120. Therefore, the CRT 120 coil inductance increases by a factor of F due to being covered by the ferrite of the receiver. Thus, the impedance in this case is given by:

$${Z}_{nl} = {iwL}_{RT} F + \frac{1}{{iwC}_{RT}} + {R}^{′} + \frac{{k}^{2} {w}^{2} {L}_{RT} {L}_{s}}{{iwL}_{s} {Y}_{s} + {R}_{l}}$$

Setting the argument to zero: wLₛYₛ+Rₗ=0 will provide maximal detuning, and select the receiver capacitor Cₛ. Note: this condition implies that the resonance point of the receiver is higher than the preferred operational frequency [fop].

Therefore:

$${Z}_{l} = {iwL}_{RT} F + \frac{1}{{iwC}_{RT}} + {R}^{′} + \frac{{k}^{2} {w}^{2} {L}_{RT} {L}_{s}}{2 {R}_{l}} ( 1 + i )$$

When the imaginary argument of the impedance is 0, the resonance frequency of the above setup would be:

$$0 = {iwL}_{RT} F + \frac{1}{{iwC}_{RT}} + i \frac{{k}^{2} {w}^{2} {L}_{RR} {L}_{s}}{2 {R}_{l}}$$

$$\frac{1}{w {C}_{rRT}} = {wL}_{RT} F + \frac{{k}^{2} {w}^{2} {L}_{RT} {L}_{s}}{2 {R}_{l}}$$

Given a preferred operational frequency fop expressed as radial angle, selected values for inductances of coils, and the coupling, the capacitor C_{RT} can be calculated. Thus the remaining impedance of the transmitting branch can be obtained by:

$${Z}_{l} = {R}^{′} + \frac{{k}^{2} {w}^{2} {L}_{RT} {L}_{s}}{2 {R}_{l}}$$

The impedance of the non-loaded transmitting branch can be expressed by:

$${Z}_{nl} = {iwL}_{R T} + \frac{1}{{iwC}_{RT}} + {R}^{′} = {iwL}_{RT} ( ( 1 - F ) - \frac{{k}^{2} {wL}_{s}}{2 {R}_{l}} ) + {R}^{′}$$

Omitting parasitic resistance will yield the following equation:

$$\vert \frac{{Z}_{nl}}{{Z}_{l}} \vert = \frac{\frac{{k}^{2} {wL}_{s}}{2 {R}_{l}} + F - 1}{\frac{{k}^{2} {wL}_{s}}{2 {R}_{l}}} = \vert \frac{\frac{{k}^{2}}{2 {Y}_{s}} + F - 1}{\frac{{k}^{2}}{2 {Y}_{s}}} \vert$$

Since

$$\frac{{k}^{2}}{2 {Y}_{s}}$$

is typically negative and smaller then 1, then the overall increase factor is

$$1 << F < \vert \frac{{Z}_{nl}}{{Z}_{l}} \vert ,$$

Which implies that the impedance of a branch without receiver 210/280 on top of it, vs. a branch with active receiver 210/280 on top, will be >>1, and currents in the non-covered transmitting branches would be significantly lower than the branch covered by receiver 210/280, as desired.

It should be noted that in order to get a relatively uniform response across the receiver side of repeater 100 the RTCs 120 are arranged in a single layer and are situated in a regular pattern or hexagon pattern formation.

Referring now to FIG. 5 showing a flowchart diagram of a method of using the wireless power charging system with the multi-coil repeater, in accordance with some exemplary embodiments of the disclosed subject matter. One of the objectives of the method is to determine an operational frequency [fₒₚ] of transmitter 300 based on a joint frequency [fj]. The joint frequency [fj] represents a shifted resonance frequency of an RTC 120 resulting from the presence of a receiver 210/280. It should be noted that the natural resonance frequency of all the transmitting branch (C_{RT} and L_{RT}) can be the same and derived from the C_{RT} and L_{RT} value.

It should be noted that resonance circuits, such as the transmitting branch (C_{RT} and L_{RT}), optimal power transmission capability occur at frequency that is substantially close to their resonance frequency, i.e. lowest impedance.

As previously described, the inductance of any given RTC 120 increases due to another coil ferrite that faces it, such as the coil of receiver 210/280. The increase in inductance is related to the coils ferrite structure and material and their proximity and alignment to one another. It will be understood that in the present disclosure, the inductance further increases due to the ferrite layers that sandwich the coils. Consequently, the resonance frequency of RTC 120 having a receiver 210/280 situated above it, decreases. At the same time, the resonance frequency of the rest of the RTCs 120 (not covered by a receiver) sustain their natural resonance frequency.

The behavior of the transmitting branch (C_{RT} and L_{RT}) described above can be utilized in the passive multi-coil repeater 100 for selecting only RTCs 120 that are covered by a receiver, and actually need to be charged, without wasting power on RTCs 120 that are not in need. In another words, since the transmitting branches as well as the receiving branches are all connected in parallel, the overwhelming part of the current induced from transmitter 300 to the receiving branch, will flow through the covered RTC 120. Providing that the [fₒₚ] of transmitter 300 is close to [fj] of the covered RTC 120, thus posing low impedance, the rest of the RTC 120 sustain their natural resonance frequency and thus posing high impedance.

In some exemplary embodiments, a minimum frequency [fₘᵢₙ] can be defined as a frequency that is close and lower than the resonance frequency of a transmitting branch fully covered by, aligned with, and close to the receiver 210/280.

In some exemplary embodiments, a maximum frequency [fₘₐₓ] can be defined as a frequency that is close and higher than the natural resonance frequency of a transmitting branch, i.e. no receiver 210/280 around.

In step 501, a frequency range is scanned and a transmitter power output for each frequency is obtained. In some exemplary embodiments, the transmitter 300 can scan frequencies ranging from fₘᵢₙ to fₘₐₓ at relatively low power. For each frequency in the range, the transmitter 300 registers its either measured or calculated output power (alternatively coil current or voltage can be used).

In step 502, the lowest frequency at which the power is minimal can be determined. In some exemplary embodiments, the lowest frequency represents the joint frequency [fj] which represents the shifted resonance frequency of the RTC 120 with most coverage.

In step 503, an operational frequency [fop] of the transmitter 300 can be set to a frequency that is substantially close to the [fj], however not identical to it. In some exemplary embodiments, upon setting the [fop], the transmitter can start transmitting power to the repeater to enable wireless charging. In some exemplary embodiments, steps 501 to 503 can be repeated sequentially thought the wireless power charging process in order to detect movement of a receiver or changes of devices, such as removing the device or adding new device on the receiver side.

In some exemplary embodiments, the transmitter can adjust the transmitted power as per the receiver's needs. Also, transmitter 300 can start its operation at a [fop], and then change it as a result of the receiver movement. Additionally or alternatively, the [fj] can reflect involvement of more than one RTC 120 with the receiver 210/280, which will result in significant amount of current flowing in the involved RTCs 120. It should be noted that the amount of current flowing in each of the involved RTC 120 can be relative to its alignment with the receiver 210/280. In spite of such incomplete coverage, the [fj] of the involved RTCs 120 is substantially lower than the natural resonance frequency.

The present disclosed subject matter may be a system, a method, and/or a computer program product. The computer program product may include a computer readable storage medium (or media) having computer readable program instructions thereon for causing a processor to carry out aspects of the present disclosed subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosed subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosed subject matter.

Aspects of the present disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosed subject matter has been presented for purposes of illustration and description, but is not intended to be exhaustive or limited to the disclosed subject matter in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

1. A multi-coil repeater for wireless power transfer from a transmitter, having an adjustable operation frequency, to a receiver coil having a ferrite layer behind it, the multi-coil repeater comprising:
an array of passive repeater transmitting coils (RTC) in a single layer;
a ferrite layer having a receiver facing side and a transmitter facing side,
wherein the array is positioned on the receiver facing side; and
a repeater receiving coil (RRC) positioned on the transmitter facing side;
wherein each RTC of the array has a resonance capacitor to form a branch having a resonance frequency, wherein all branches are parallelly wired together, wherein a receiver placed above the receiver facing side causes the resonance frequency of at least one branch positioned directly below the receiver to drop to a different resonance frequency; and wherein the transmitter adjusts its operational frequency to the RRC to be close to the different resonance frequency of the at least one branch.

2. The multi-coil repeater of claim 1, wherein said receiver coil having a ferrite layer behind it and the ferrite layer sandwich the receiver coil and the RTC in between contributes to the drop of the resonance frequency.

3. The multi-coil repeater of claim 1, wherein the RTC is substantially smaller than the RRC.

4. The multi-coil repeater of claim 1, wherein the RTC is substantially smaller than a typical receiver coil to enable coverage of at least RTCs by the receiver coil.

5. A method for adjusting an operational frequency for the multi-coil repeater of claim 1, the method comprising:
scanning a range of operational frequencies of the transmitter and registering a power output for each frequency of the range of the operational frequencies;
determining a lowest frequency in which the power output is minimal;
set the operational frequency to be substantially close to the lowest frequency and start transmitting to the RRC.

6. The method of claim 5, wherein said adjusting an operational frequency is repeated sequentially for detecting a movement of the receiver on the receiver facing side and additional receivers.

7. The method of claim 5, wherein the transmitter adjusts the power output to satisfy power needs of the receiver.

8. The method of claim 5, wherein said lowest frequency in which the power output is minimal is a joint resonance frequency of the at least one branch and the receiver coil of a receiver positioned above the at least one branch.

9. The method of claim 8, wherein the joint resonance frequency is substantially lower than a resonance frequency of a branch that doesn't have a receiver above it, thereby the operational frequency effectively selects only the at least one branch positioned bellow the receiver.
